(19) United States
(12) Patent Application Publication
(10) Pub. No.: US 2009/0295211 A1
(43) Pub. Date: Dec. 3, 2009

(54) Foldable head restraint for motor vehicle

(75) Inventor: Ove Granath, Bankeryd (SE)

Correspondence Address: EDWARDS ANGELL PALMER & DODGE LLP, P.O. BOX 55874, BOSTON, MA, 02205, US

(73) Assignee: Kongsberg Automotive, Kongsberg (NO)

(21) Appl. No.: 11/661,890

(22) PCT Filed: Sep. 6, 2005
(86) PCT No.: PCT/SE2005/001289

§ 371 Date: Aug. 10, 2009

Related U.S. Application Data
(60) Provisional application No. 60/607,266, filed on Sep. 7, 2004.

(30) Foreign Application Priority Data
Sep. 7, 2004 (SE) SE0402174-7

(51) Int. Cl. B60N 2/48

(52) U.S. Cl. 297/403

(57) ABSTRACT

Folding head restraint for motor vehicles, that can rotate around a horizontal pivot axis between an in-use position and a non-use position, and that can be locked in the in-use position by means of a locking mechanism (23). The head restraint consists of a head-restraint cushion (1) that is supported on a supporting structure (2). This comprises a framework for the head-restraint cushion and a fixing bracket (6) for attaching the head restraint to the back structure of the vehicle seat and also supports (3, 4). These are mounted at one end in such a way that they can pivot around the pivot axis and are attached at the other end to the framework of the head-restraint cushion. The supports extend through the opening (13) in an upper part of the backrest and have an arc-shaped curved part (10, 11) with essentially the pivot axis (5) as the centre of curvature. The supports can be rotated in an essentially unchanged path of movement (12) without lateral movements. The openings can have shapes and dimensions that do not significantly exceed the cross-sectional shape and dimensions of the supports. One end of the arc-shaped curved part (10, 11) of the support or supports (3,4) is attached to the pivot axis by means of a locking arm (17, 18) that has a locking device (24) that is comprised in the locking mechanism (23).

### TECHNICAL FIELD

The present invention relates to a folding head restraint according to the preamble to the following claim 1.

### BACKGROUND ART

Folding head restraints in which the supports are arc-shaped in order to achieve the effect with a limited hole through the cover panel in the backrest are already known through the patent publications GB 2 325 403 and DE 3939453. These known solutions have their pivot axis fully integrated into the backrest structure and are therefore difficult to implement in existing vehicles.

### DISCLOSURE OF INVENTION

The object of the present invention is to produce a head restraint that has an arc-shaped curved part and an integrated locking mechanism.

The said object is achieved by means of a head restraint according to the characterizing part of claim 1.

### BRIEF DESCRIPTION OF DRAWINGS

The invention will be described in the following in greater detail in the form of an embodiment, with reference to the attached drawings in which

FIG. 1 shows the head restraint and the incorporated supporting structure with locking mechanism,

FIG. 2 shows the supporting structure and a part of the locking mechanism in a perspective view,

FIG. 3 is an enlarged partial view of FIG. 2, and

FIG. 4 is a side view of the head restraint and the incorporated structure in an unfolded locked position and in a folded position.

### MODE(S) FOR CARRYING OUT THE INVENTION

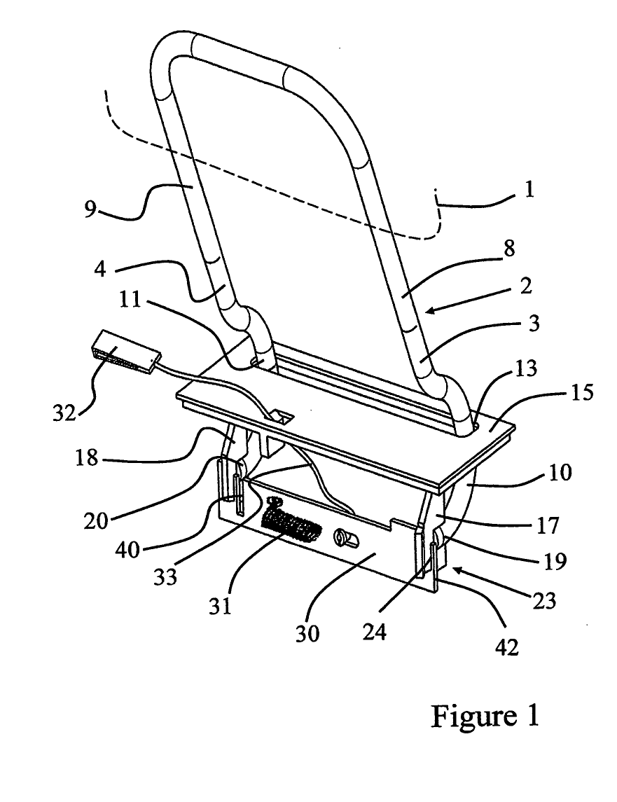

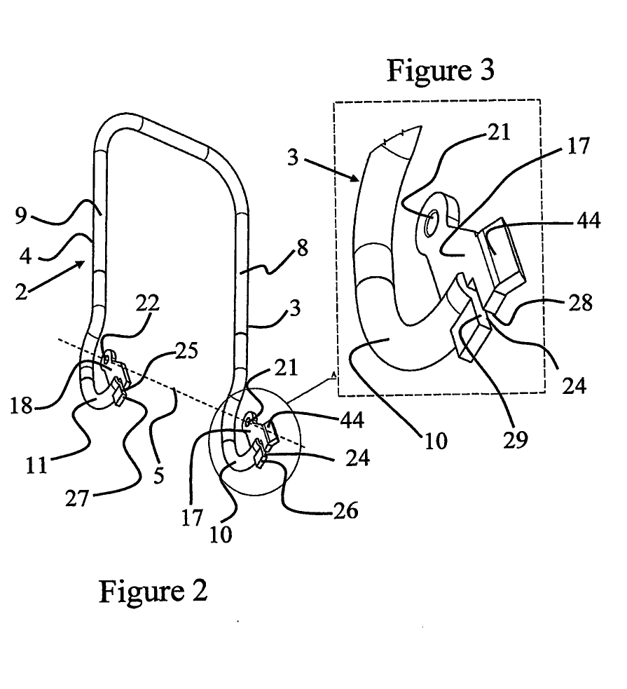

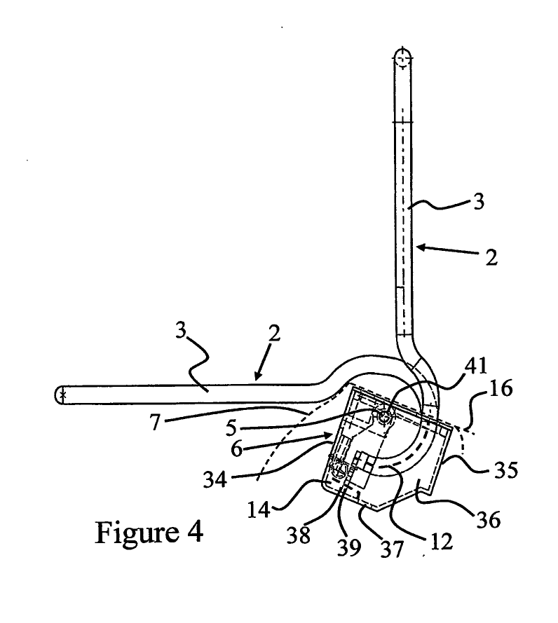

As shown in FIG. 1, the head restraint consists of a head-restraint cushion 1 that is indicated in part by chain-dotted lines and can be of conventional type, and a supporting structure 2 that supports the head-restraint cushion. The supporting structure has a framework for the head-restraint cushion, which framework can similarly be of conventional type and is not shown and is attached to a connecting part between two supports 3, 4, the top ends of which are inserted into the head-restraint cushion 1 and the bottom ends of which are mounted in such a way that they can pivot on an essentially horizontal pivot axis 5 that is shown schematically in FIGS. 2 and 4 and can, for example, consist of a metal rod that is attached to a fixing bracket 6 or casing in the form of a box or framework that is arranged to be attached to an upper part of the backrest 7 of the vehicle seat, as indicated by the chain-dotted line in FIG. 4. Alternatively, the pivot axis 5 can consist of two opposing screws along the same axis.

The supports each have a relatively straight part 8, 9 at the top end. Lower down, the straight parts become curved parts 10, 11 that, for example, are in the form of an arc, for example a semicircle. As indicated in FIG. 2, the form can differ from a semicircle, but is at least partially an arc. Most of the centre of curvature of the arc-shaped parts coincides with the pivot axis 5, whereby the arc-shaped parts follow an essentially unchanged path of movement 12 that is indicated by a chain-dotted line, that is the arc-shaped parts do not move sideways during the rotational movement, even when viewed in three dimensions. The supports 3, 4 extend through separate openings or a single opening 13 in a cover panel 15 that forms a cover for the fixing bracket or casing 6. By means of the shape in the form of an arc and the centre of rotation of the pivot axis 5, from the outside the openings that are visible to a viewer can be given shapes and dimensions that do not significantly exceed the cross-sectional shape and dimensions of the supports, more specifically the section that lies in the plane 16 of the cover panel 15 that is indicated by a chain-dotted line in FIG. 4. In the example shown, the opening is shown as an elongated opening that is common to both supports 3, 4 which, when finally assembled, is covered between the supports either by a plate or by the material of the backrest, whereby the casing 6 is completely incorporated into the backrest. More specifically, the part in the form of an arc has advantageously an arc angle that is equal to or exceeds the angle of rotation between the unfolded and the folded positions of the supports 3, 4.

The arc-shaped parts 10, 11 are attached to the fixing bracket in such a way that they can rotate or, more specifically, are attached in such a way that they can rotate around the pivot axis 5 by means of their arms 17, 18 respectively. These arms 17, 18 are designed as plates constructed of a plate material and extend in a radial plane to the pivot axis 5 and are attached to the lower end 19, 20 of the arc-shaped parts 10, 11 of the supports, for example by welding. The supports are constructed of a rod or tubular material and are suitably provided with a slot in the end dimensioned to receive a part of the plate-shaped arms 17, 18 that is suitably welded onto the arms, whereby a permanent durable fixing is achieved, see FIGS. 2 and 3. The arms 17, 18 each have a hole 21, 22 at their free end through which the pivot axis 5 passes, with the pivot axis either being fixed in the hole and pivoting in the fixing bracket or being fixed to the fixing bracket and pivoting in the holes 21, 22.

According to the invention, the arms 17, 18 are designed as locking arms comprised in a locking mechanism 23 arranged to lock the head restraint in its in-use position, as shown in FIGS. 1 and 4, with erect supports 3, 4. For this purpose, the locking arms have a recess 24, 25 which is open towards a lower edge 26, 27 of the locking arms 17, 18. The operating parts of the locking recess 24, 25 are two opposing suitably parallel locking edges 28, 29 that are arranged to interact with a locking plate 30 that can move in an axial direction and that extends at right angles to the locking arms 17, 18 and is longer than the distance between the locking arms. The locking plate 30 can move in a longitudinal direction in a guide 14 shown schematically in FIG. 4, which guide prevents the locking plate from moving at right angles to its longitudinal direction. As shown in FIGS. 1 and 4, the locking plate is pre-tensioned to assume the locking position by means of a draw spring 31 that urges the locking plate 30 to the right in FIG. 1. By means of an operating device 32, the locking plate and the locking mechanism can be released by an operating movement against the action of the draw spring via a draw wire 33, which is attached to the locking plate and can pull the locking plate to the left in FIG. 1. One end of the draw spring 30 is attached to a fixed point in the casing 6 and the other end is attached to the locking plate.

In addition to the active parts described above, it can be added that the casing or fixing bracket 6 is designed as a box with two longitudinal side walls 34, 35, with the draw spring 31 being attached to, for example, the nearest wall, and two opposing end walls 36, one of which can be seen in FIG. 4. A cover, that can be a separate unit, forms a cover panel, while an under part 37 or any other of the walls of the casing forms a point of attachment to the back structure of the backrest 7. Screw connections (not shown) can be used to make a secure and load-absorbing fixing through holes in the wall of the casing. The under part can be designed differently for different ways of fixing.

The pivot axis 5 is either attached to the end walls 36 or supported by brackets (not shown) in the casing. The locking plate 30 is thus guided by a guide that is only shown schematically and that has at least two guide walls 38, 39, see FIG. 4. These enable the locking plate 30 to move in its longitudinal direction, but prevent it from moving in other directions. The locking plate is shorter than the distance between the end walls 36, but is longer than the distance between the locking arms 26, 27. For one locking arm 18, the locking plate is provided with a U-shaped recess 40 that has a width that exceeds the thickness of the locking arm 18 so that in a releasing position the supports 3, 4 with the locking arms 17 and 18 can rotate around the pivot axis 5 and in a locking position they are locked by the locking plate being inserted in the recess 28 in the locking arms. A torsion spring 41 that is shown in FIG. 4 urges the head restraint in a direction towards the non-use position and keeps it in the non-use position, see the horizontal position according to FIG. 4. As mentioned, in a simple embodiment, the pivot axis 5 can be represented by two screws in the end walls, with the screws going through holes 21 in the locking arms 17, 18. By making one screw longer, the torsion spring 41 can be supported and guided by the screw.

To summarize, the function of the head restraint is as follows. In the non-use position, that is the folded position, see FIG. 4, the locking plate 30 is outside the locking arms 17, 18 while at the same time one end 42 of the locking plate is pre-tensioned against an end stop (not shown) by means of the draw spring 31. The torsion spring 41 urges the head restraint to remain in this position. To avoid ambiguity, in FIG. 4 the locking plate is only shown in the locking position, that is with the head restraint in the unfolded position.

The head restraint can be unfolded manually by taking hold of the head restraint cushion 1 and rotating the head restraint upwards against the action of the torsion spring 41. The end position of the locking plate 30 has been selected so that during the unfolding movement the end 42 of the locking plate comes into contact with an angled guide part 44 of one locking arm which, by means of an angled guide surface against the end 42 of the locking plate, presses back the locking plate against the action of the draw spring 31 until the recess 40 for the other locking arm 18 is aligned with the locking arm, that is within its plane, so that the locking arm can be inserted into the recess during the unfolding towards the unfolded position, that is the in-use position. Here the locking plate 30 is aligned with the recesses 25, 26 in the locking arms and is pressed into these by the action of the draw spring 31. The recess 40 in the locking plate 30 then comes outside the plane of the locking arm 18. The head restraint is thereby locked in the upright position. Folding away is carried out in reverse, by activating the operating device 32 which creates a pulling movement of the locking plate against the action of the draw spring 31, until the locking edges of the locking plate leave the recesses in the locking arms, that is the recess 40 in the locking plate aligns with one locking arm and the end 42 of the locking plate leaves the recess in the other locking arm. The locking mechanism is thereby in the releasing position and the head restraint is folded away to the non-use position by the action of the torsion spring 41.

The invention is not limited to the examples described above and shown in the drawings. The supports can vary in number and in cross section. In an embodiment with a single support, this can be elongated to maintain stability, for example, it can be constructed as a plate or profile with curved parts that extend through an opening in the form of a slot. In its simplest form, the opening that is visible to a viewer is round or circular, but it can be angular, for example square, to match the cross section of the support. To absorb minor deviations in the path of movement, it is possible for the cover panel 15 with the opening or openings 13 to be attached in such a way that it “floats”, that is so that it can move sideways to a certain extent. The locking plate can be positioned in different ways and can, in principle, have recesses in both locking arms. The arc length of the arc-shaped parts can vary according to the angular distance between the two end positions, but should, in principle, be a corresponding length to the supports. It is also possible for the arc-shaped part of the supports to deviate somewhat from an arc shape. What is important is that the extent of the openings can be limited, at least in the plane of rotation of the supports, to essentially the cross-sectional dimension of the supports, viewed in a final-assembled state.

1-5. (canceled)

6. A folding head restraint for use in motor vehicles, comprising:
the folding head restraint configured to rotate about a pivot axis between a use position and a non-use position;
a fixing bracket for attaching the folding head restraint to a backrest of a vehicle seat;
a supporting structure for receiving a head-restraint cushion, the supporting structure including at least one support having an arc-shaped curved part pivotable about the pivot axis and a locking arm extending from the arc-shaved curved part, the locking arm having a recess; and
a locking mechanism for locking the folding head restraint in the use position, the locking mechanism including a locking plate movable axially so as to engage the recess of the locking arm to lock the head restraint in the use position.

7. The folding head restraint of claim 6, wherein the locking plate includes at least one recess arranged outside a plane of the locking arm in a locking position, the recess coinciding with the plane of the locking arm in a releasing position.

8. The folding head restraint of claim 6, wherein the supporting structure includes two supports, each support being pivotable around the pivot axis.

9. The folding head restraint of claim 8, wherein each of the two supports includes the arc-shaped curved part and the locking arm.

10. The folding head restraint of claim 8, wherein the bracket includes a cover panel, and the supports extend through at least one opening in the cover panel.

11. The folding head restraint of claim 6, wherein the locking arm includes a pair of opposing locking edges defining the recess for engaging the locking plate, the locking plate being movable axially between the opposing locking edges.

12. The folding head restraint of claim 6, wherein the locking plate is movable longitudinally in a guide, and restrained from movement in a direction of rotation of the folding head restraint.

13. The folding head restraint of claim 6, further comprising a spring mechanism connected to the locking plate, the spring mechanism biasing the locking plate within the recess of the locking arm, so as to lock the folding head restraint in the use position.

14. The folding head restraint of claim 13, further comprising an operating device operable to pull the locking plate against the bias of the spring mechanism, so as to release the locking plate from the recess of the locking arm, so as to move the folding head restraint to the non-use position.

15. The folding head restraint of claim 13, wherein the supporting structure includes two supports, each of the two supports including the arc-shaped curved part and the locking arm, wherein at least one of the locking arms has an angled guide part configured to contact the locking plate during rotation of the folding head restraint from the non-use position to the use position.

16. The folding head restraint of claim 15, wherein the angled guide part holds the locking plate in contact with one side of the locking arm, until the recess of the locking arm in the use position enables the locking plate in a locking position to be inserted in the recess of the locking arm by action of the spring mechanism.

17. The folding head restraint of claim 6, wherein the at least one support pivots about the pivot axis substantially without lateral movement.

18. The folding head restraint of claim 6, wherein the at least one support extends through at least one opening in the backrest, the opening having a size that substantially does not exceed a size of the at least one support.

19. The folding head restraint of claim 6, wherein the at least one support includes a relatively straight part at a top end, the straight part becoming curved and forming the arc-shaped curved part that substantially coincides with the pivot axis.

20. A motor vehicle seat comprising the folding head restraint of claim 6.

21. A motor vehicle comprising the folding head restraint of claim 6.

22. A folding head restraint for use in motor vehicles, the folding head restraint configured to rotate about a pivot axis between a use position and a non-use position, comprising:
a fixing bracket for attaching the folding head restraint to a backrest of a vehicle seat;
a supporting structure for receiving a head-restraint cushion, the supporting structure including two supports each having an arc-shaped curved part pivotable about the pivot axis and a locking arm extending from the arc-shaved curved part, the locking arm having a recess; and
a locking mechanism for locking the folding head restraint in the use position, the locking mechanism including a locking plate movable axially so as to engage the recess of the locking arm to lock the head restraint in the use position.

23. The folding head restraint of claim 22, wherein at least one of the locking arms has an angled guide part configured to contact the locking plate during rotation of the folding head restraint from the non-use position to the use position.

24. The folding head restraint of claim 22, wherein the locking plate includes at least one recess arranged outside a plane of the locking arm in a locking position, the recess coinciding with the plane of the locking arm in a releasing position.

25. The folding head restraint of claim 22, further comprising a spring mechanism connected to the locking plate, the spring mechanism biasing the locking plate within the recess of the locking arm, so as to lock the folding head restraint in the use position.
